(19) United States
(12) Patent Application Publication
(10) Pub. No.: US 2026/0167543 A1
(43) Pub. Date: Jun. 18, 2026

(54) WATER TREATMENT SYSTEM

(71) Applicant: KYUNGDONG NAVIEN CO., LTD., Pyeongtaek-si Gyeonggi-do (KR)

(72) Inventors: Young Jo LIM, Seoul (KR); Soo Young LEE, Seoul (KR); Gwang Hee CHO, Seoul (KR)

(73) Assignee: KYUNGDONG NAVIEN CO., LTD., Pyeongtaek-si Gyeonggi-do (KR)

(21) Appl. No.: 19/419,522

(22) Filed: Dec. 15, 2025

(30) Foreign Application Priority Data
Dec. 16, 2024 (KR) 10-2024-0187398

(51) Int. Cl. C02F 9/00; C02F 1/461; C02F 1/469; C02F 1/68

(52) U.S. Cl. CPC C02F 9/00; C02F 1/461; C02F 1/4691; C02F 1/4693; C02F 1/68; C02F 2201/004; C02F 2201/005; C02F 2209/40; C02F 2303/16; C02F 2303/22

(57) ABSTRACT

The water treatment system may include a filter module that is configured to be operated in a removal mode, and in a regeneration mode for regenerating an electrode, a supply passage that supplies the raw water to the filter module, a discharge passage that guides the soft water discharged from the filter module to a demand destination, a bypass passage that is branched from the supply passage at a point on an upstream side of the filter module with respect to a flow direction of the raw water, and is connected to the discharge passage while bypassing the filter module, a bypass sensor that is disposed on the bypass passage, and senses flow of the raw water through the bypass passage, and a processor electrically that is connected to the filter module and the bypass sensor.

### CROSS-REFERENCE TO RELATED APPLICATION

This application claims the benefit of priority to Korean Patent Application No. 10-2024-0187398, filed in the Korean Intellectual Property Office on Dec. 16, 2024, the entire contents of which are incorporated herein by reference.

### TECHNICAL FIELD

The present disclosure relates to a water treatment system.

### BACKGROUND

A water treatment system is a system that produces soft water from raw water supplied from a water source and supplies the soft water to a demand destination. For example, in a Point of Entry (PoE) type water treatment system, the demand destination may be a house, and the soft water delivered to the demand destination is further supplied to water outlets, shower heads, and other points, at which water is used.

A filter module that removes ionic material from raw water to convert the raw water into soft water is not permanently usable, and even a semi-permanent filter module has to undergo a regeneration operation to discharge the collected ionic material at regular intervals to function properly.

Meanwhile, if the use of the water treatment system is interrupted during an operation of removing ionic material by the filter module, the power supplied to the filter module may be cut off, and the ionic material may be desorbed again. When the water treatment system is restarted thereafter, the desorbed ionic material is supplied to the demand destination.

To prevent this, a regeneration operation may be performed by the filter module for a specific period of time, but regeneration water may be wasted as the regeneration operation is performed. Accordingly, there is an increasing need for a water treatment system that reduces the regeneration water wasted during the regeneration operation.

### SUMMARY

The present disclosure has been made to solve the above-mentioned problems occurring in the prior art while advantages achieved by the prior art are maintained intact.

The present disclosure provides a water treatment system that, when operation is resumed after an interruption, reduces the regeneration water wasted during the regeneration operation and secures an improved recovery rate.

The technical problems to be solved by the present disclosure are not limited to the aforementioned problems, and any other technical problems not mentioned herein will be clearly understood from the following description by those skilled in the art to which the present disclosure pertains.

According to an aspect of the present disclosure, a water treatment system includes a filter module that is configured to be operated in a removal mode, in which a voltage is applied to remove at least a portion of ionic material included in raw water based on an electrical force and discharge soft water, and in a regeneration mode for regenerating an electrode, a supply passage that supplies the raw water to the filter module, a discharge passage that guides the soft water discharged from the filter module to a demand destination, a bypass passage that is branched from the supply passage at a point on an upstream side of the filter module with respect to a flow direction of the raw water, and is connected to the discharge passage while bypassing the filter module, a bypass sensor that is disposed on the bypass passage, and senses flow of the raw water through the bypass passage, and a processor electrically that is connected to the filter module and the bypass sensor, and the processor may be configured to apply a voltage to the filter module at a voltage level used in the removal mode, in response to the flow of the raw water through the bypass passage being sensed by the bypass sensor.

The water treatment system may further include a bypass valve that is disposed on the bypass passage, opens and closes the bypass passage, and is electrically connected to the processor, and the processor may be configured to control the bypass valve such that the bypass passage is closed after the voltage at the level used in the removal mode is applied to the filter module for a specific period of time.

The water treatment system may further include a discharge valve that is disposed on the discharge passage, opens and closes the discharge passage, and is electrically connected to the processor, and the processor may be configured to control the discharge valve such that the discharge passage is opened after the voltage at the level used in the removal mode is applied to the filter module for the specific period of time.

The discharge valve may be located on an upstream side of a point, at which the bypass passage is connected to the discharge passage, with respect to a flow direction of the soft water.

The water treatment system may further include a discharge flow rate sensor that is provided on the discharge passage, measures a flow rate of the soft water or the raw water flowing through the discharge passage, and is electrically connected to the processor, and the processor may be configured to acquire information on an amount of the ionic material removed by the filter module in response to the discharge flow rate sensor sensing that the soft water or the raw water does not flow through the discharge passage.

The processor may be configured to apply a voltage to the filter module at the voltage when the filter module is operated in the removal mode or an opposite voltage to the voltage, based on the amount of the removed ionic material.

The processor may be configured to control the filter module such that the filter module is operated in the regeneration mode after a specific period of time in response to the amount of the removed ionic material being a reference value or more.

The processor may be configured to control the bypass valve such that the bypass passage is opened in response to the amount of the removed ionic material being less than a reference value.

The water treatment system may further include a discharge valve that is disposed on the discharge passage, opens and closes the discharge passage, and is electrically connected to the processor, and the processor may be configured to control the discharge valve such that the discharge passage is closed in response to the amount of the removed material being less than a reference value.

The water treatment system may further include a regeneration passage that is branched from the discharge passage, and a regeneration valve that is disposed on the regeneration passage, opens and closes the regeneration passage, and is electrically connected to the processor, and the processor may be configured to control the regeneration valve such that the regeneration passage is closed in response to the amount of the removed ionic material being less than a reference value.

The water treatment system may further include a supply valve that is located on a downstream side of a point, at which the bypass passage is branched from the supply passage, with respect to a flow direction of the raw water, opens and closes the supply passage, and is electrically connected to the processor, and the processor may be configured to control the supply valve such that the supply passage is opened in response to the amount of the removed ionic material being less than a reference value.

Information on the amount of the removed ionic material may be estimated by the processor or measured by the filter module.

The reference value may be formed as 50% of an adsorption capacity of the filter module.

The discharge flow rate sensor may be located on a downstream side of a point at which the bypass passage is connected to the discharge passage, with respect to a flow direction of the soft water or the raw water.

### BRIEF DESCRIPTION OF THE DRAWINGS

The above and other objects, features and advantages of the present disclosure will be more apparent from the following detailed description taken in conjunction with the accompanying drawings:

FIG. 1 is a schematic view of a water treatment system when a filter module is operated in a removal mode according to an embodiment of the present disclosure;

FIG. 2 is a conceptual view illustrating a principle, in which an ionic material is removed in a CDI method;

FIG. 3 is a schematic view of a water treatment system when a filter module is operated in a regeneration mode according to an embodiment of the present disclosure;

FIG. 4 is a conceptual view illustrating a principle, in which an electrode is regenerated by a CDI method;

FIGS. 5 and 6 are schematic views of a water treatment system, in which raw water is delivered to a demand destination through a bypass passage, according to an embodiment of the present disclosure;

FIG. 7 is a schematic view of a water treatment system, in which a filter module is operated in a removal mode to deliver soft water to a demand destination, according to an embodiment of the present disclosure;

FIG. 8 is a schematic view of a water treatment system, which is interrupted, according to an embodiment of the present disclosure;

FIG. 9 is a schematic view of a water treatment system when a filter module is operated in a regeneration mode according to an embodiment of the present disclosure; and

FIG. 10 is a flowchart illustrating a method for controlling a water treatment system, according to an embodiment of the present disclosure.

### DETAILED DESCRIPTION

Hereinafter, some embodiments of the present disclosure will be described in detail with reference to the accompanying drawings. In the drawings, the same reference numerals will be used throughout to designate the same or equivalent components. In describing embodiments of the present disclosure, detailed descriptions associated with well-known functions or configurations will be omitted if they may make subject matters of the present disclosure unnecessarily obscure.

In the specification, a forward/rearward direction, a leftward/rightward direction, and an upward/downward direction are referred for convenience, and may be directions that are perpendicular to each other. In the specification, a horizontal direction and a vertical direction are referred for convenience, and may be directions that are perpendicular to each other. However, the directions are determined relatively to a direction, in which the components of a hot water mat device are arranged, and the upward/downward direction necessarily mean a vertical direction.

Additionally, terms including ordinal numbers, such as “first,” “second,” etc., used herein may be used to describe various components, but the components are not limited by the terms, and the terms are used only for the purpose of distinguishing one component from another. For example, without departing from the scope and spirit of the present disclosure, a first component may be referred to as a second component, and similarly, the second component may be referred to as the first component. The term “and/or” includes any combination of a plurality of related listed items or any one of the plurality of related listed items.

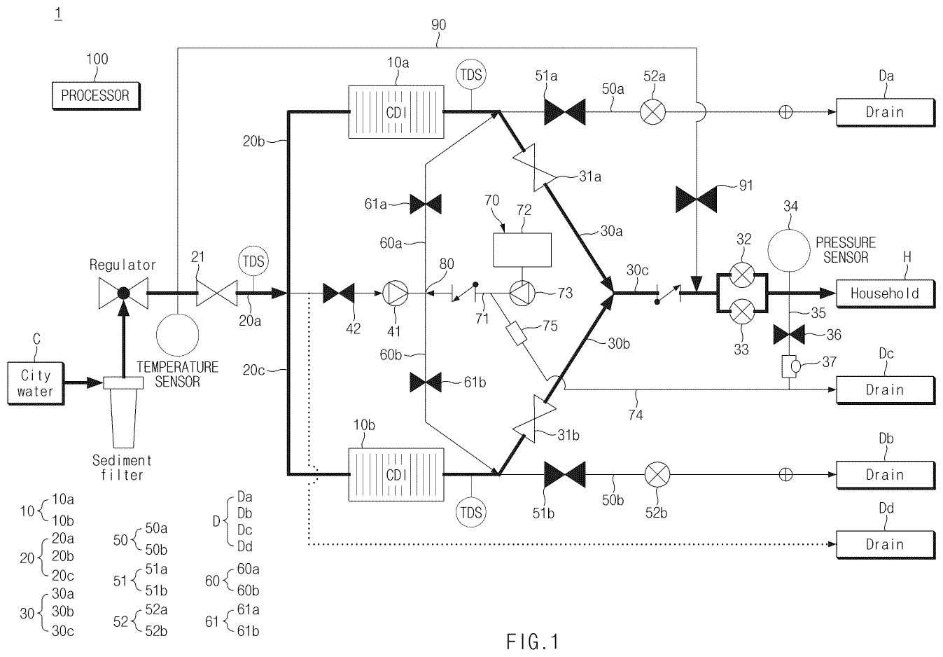

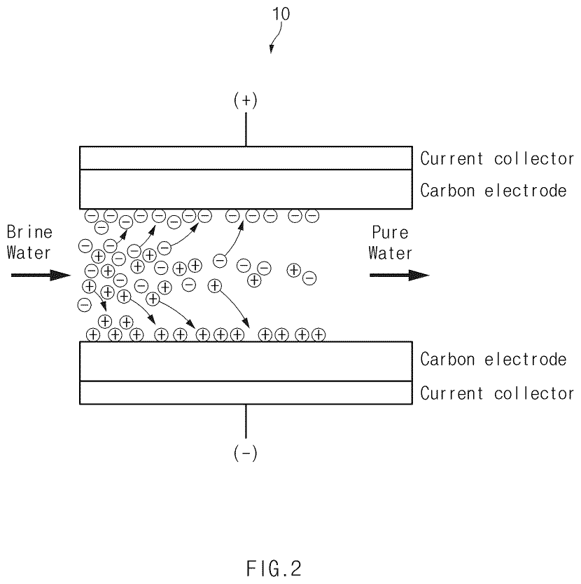

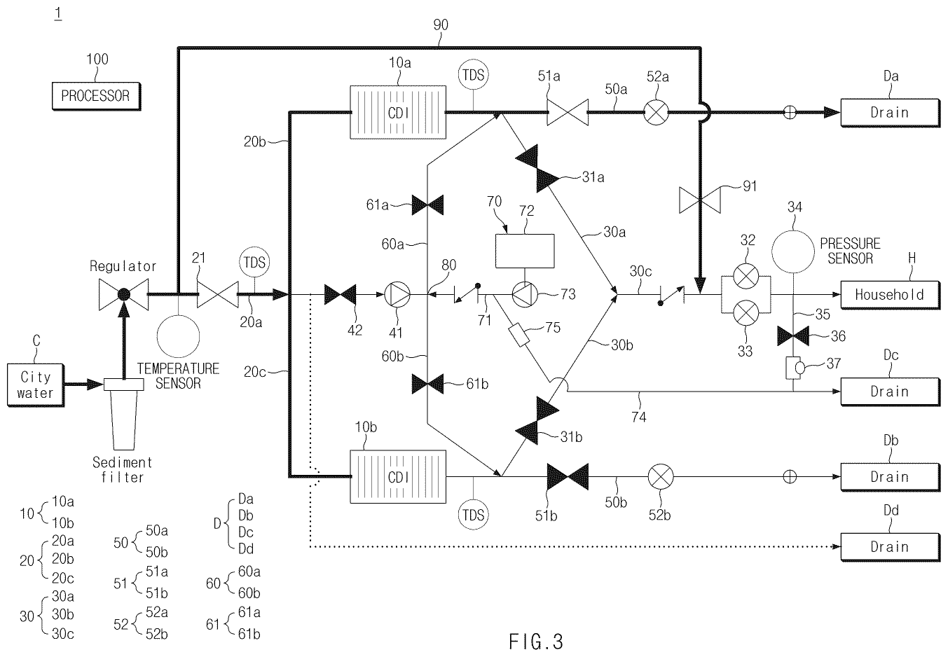

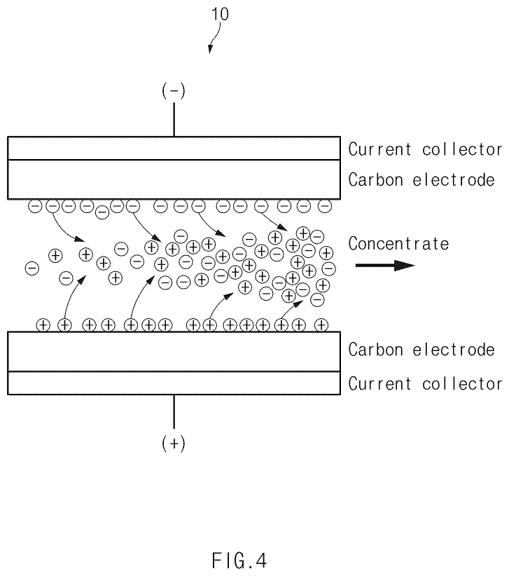

FIG. 1 is a schematic view of a water treatment system when a filter module is operated in a removal mode according to an embodiment of the present disclosure. FIG. 2 is a conceptual view illustrating a principle, in which an ionic material is removed in a CDI method. FIG. 3 is a schematic view of a water treatment system when a filter module is operated in a regeneration mode according to an embodiment of the present disclosure. FIG. 4 is a conceptual view illustrating a principle, in which an electrode is regenerated by a CDI method.

Referring to FIGS. 1 to 4, a water treatment system 1 may include a water source C, a demand destination H, and a drain D. The water source C may be a point, at which raw water is supplied to the water treatment system 1. The demand destination H may be a point, at which raw water or soft water is supplied from the water treatment system 1.

The drain D may be a point, at which the water treatment system 1 discharges raw water or regeneration water received from the water source C. The drain D may include a first drain Da, a second drain Db, a third drain Dc, and a fourth drain Dd.

The water treatment system 1 may include a filter module 10, a supply passage 20, a discharge passage 30, and a regeneration passage 50.

The filter module 10 may remove ionic material from raw water by a capacitive deionization (CDI) method, which is one type of electrical deionization method. The CDI method refers to a method for removing ions by using a principle, in which ions (or ionic materials) are adsorbed to and desorbed from surfaces of electrodes by an electrical force.

The filter module 10 may be provided with raw water delivered from the water source C, and the filter module 10 may remove at least a portion of ionic material included in the provided raw water based on an electrical force to generate and discharge soft water. Furthermore, the filter module 10 may discharge ionic material from the provided raw water to generate and discharge regeneration water.

More specifically, raw water may be supplied from the water source C to the filter module 10 by the supply passage 20. The filter module 10 may remove at least a portion of ionic material included in the raw water and discharge soft water to the discharge passage 30. The discharge passage 30 may deliver soft water discharged from the filter module 10 to the demand destination H.

Meanwhile, the filter module 10 may be formed to be operated in a removal mode, in which a voltage is applied to remove at least a portion of ionic material included in raw water based on an electrical force and discharge soft water, and in a regeneration mode for regenerating an electrode.

In the removal mode, as illustrated in FIG. 2, when water including ions passes between electrodes while a voltage is applied to the electrodes, anions move to the anode, and cations move to the cathode. That is, adsorption occurs. Through the adsorption, ions may be removed from the water. In this way, a mode, in which ions (ionic material) in water that passes through the filter module 10 are removed through the electrodes, is referred to as the removal mode.

However, the adsorption capacity of the electrodes is limited. Accordingly, as adsorption continues, the electrodes reach a state, in which they can no longer adsorb ions. To prevent this, it is necessary to regenerate the electrode by desorbing the ions adsorbed onto the electrode.

To this end, as illustrated in FIGS. 3 and 4, an opposite voltage to the voltage applied in the removal mode may be applied to the electrode of the filter module 10, or a voltage may not be applied. In this way, a mode, in which the filter module 10 regenerates the electrode, is referred to as a regeneration mode. The regeneration mode may be performed before or after the removal mode.

When the filter module 10 is in the regeneration mode, raw water may be supplied from the water source C, and the raw water may be discharged to the first and second drains Da and Db through the regeneration passage 50.

Accordingly, to perform such an operation, the filter module 10 may include an electrode. The filter module 10 may selectively perform any one of a removal mode for removing an ionic material by an electrodialysis method, and a regeneration mode for regenerating the electrode.

Accordingly, when raw water is supplied to the filter module 10, in the removal mode, soft water may be generated by removing at least a portion of the ionic material in the raw water, and the filter module 10 may discharge the soft water, and in the regeneration mode, the ionic material contained in the electrode may be provided to the raw water, and the filter module 10 may discharge the water, of which a content of the ionic material has been increased.

The filter module 10 may include a first filter module 10a and a second filter module 10b. The first filter module 10a and the second filter module 10b may be used alternately or may be used together at the same time.

Meanwhile, the water treatment system 1 may include a supply passage 20 and a supply valve 21. The supply passage 20 may be configured to supply raw water to the filter module 10. The supply valve 21 may be disposed on the supply passage 20. The supply valve 21 may be disposed on the supply passage 20 to open and close the supply passage 20.

The supply valve 21 may be disposed on an upstream side of a point, at which a circulation passage 40 to be described is branched from the supply passage 20. In addition, the supply passage 20 may be provided with a sediment filter, a regulator, and a TDS sensor.

The supply passage 20 may include a first supply passage 20a that is provided with the sediment filter, the regulator, and the TDS sensor, a second supply passage 20b that is connected to the first filter module 10a from the first supply passage 20a, and a third supply passage 20c that is connected to the second filter module 10b from the first supply passage 20a. The second supply passage 20b and the third supply passage 20c may be branched from the first supply passage 20a.

The water treatment system 1 may include a discharge passage 30, a discharge valve 31, a discharge flow rate sensor 32, an anti-freezing valve 33, a pressure sensor 34, a drain passage 35, a drain valve 36, and a constant flow rate valve 37.

The discharge passage 30 may extend from the filter module 10 to the demand destination H. The discharge valve 31 may be disposed on the discharge passage 30. The discharge valve 31 may be disposed on the discharge passage 30 to open and close the discharge passage 30.

The discharge flow rate sensor 32 may be provided on the discharge passage 30 to measure a flow rate of soft water or raw water that flows through the discharge passage 30. The anti-freezing valve 33 may be provided on the discharge passage 30 to prevent the discharge passage 30 from being damaged by freezing. The discharge flow rate sensor 32 and the anti-freezing valve 33 may be connected in parallel to each other.

The pressure sensor 34 may measure a pressure of soft water or raw water that flows through the discharge passage 30. The drain passage 35 may be branched from the discharge passage 30 at a point that is downstream of the discharge flow rate sensor 32 and the anti-freezing valve 33 with respect to a flow direction of soft water or raw water.

The drain passage 35 may connect the discharge passage 30 to a third drain Dc. The drain valve 36 may be disposed on the drain passage 35 to open and close the drain passage 35. The constant flow rate valve 37 may be disposed on the drain passage 35 and may be used to maintain a flow rate flowing through the drain passage 35 at a preset flow rate.

The discharge passage 30 may include a first discharge passage 30a that is connected to the first filter module 10a, and a second discharge passage 30b that is connected to the second filter module 10b. The discharge valve 31 may include a first discharge valve 31a and a second discharge valve 31b. The first discharge valve 31a may be disposed on the first discharge passage 30a, and the second discharge valve 31b may be disposed on the second discharge passage 30b.

In addition, the discharge passage 30 may include a third discharge passage 30c that is connected to the first discharge passage 30a and the second discharge passage 30b, and is connected to the demand destination H. However, it is also possible that, without the third discharge passage 30c, the first discharge passage 30a and the second discharge passage 30b are connected to the demand destination H, respectively.

The water treatment system 1 may include a circulation passage 40, a circulation pump 41, and a circulation valve 42. The circulation passage 40 may be branched from the supply passage 20. The circulation passage 40 may be connected to a descaling part 70 to be described below and a connection passage 60.

The circulation pump 41 and the circulation valve 42 may be disposed on the circulation passage 40. The circulation pump 41 may be disposed on an upstream side of a point, at which the circulation passage 40 and the connection passage 60 are connected to each other, with respect to a flow direction of raw water. The circulation valve 42 may open and close the circulation passage 40.

The circulation pump 41 may be configured to pump a fluid that flows through the circulation passage 40. As an example, the circulation pump 41 may be configured to pump a descaling material that flows through the circulation passage 40 to a connection passage 60 to be described below.

Meanwhile, the circulation passage 40 may be connected to a fourth drain Dd, and raw water that flows through the circulation passage 40 may be discharged to the fourth drain Dd depending on the situation.

The water treatment system 1 may include a regeneration passage 50, a regeneration valve 51, and a regeneration sensor 52. The regeneration passage 50 may be branched from the discharge passage 30. The regeneration valve 51 may be disposed on the regeneration passage 50 to open and close the regeneration passage 50. The regeneration sensor 52 may sense a flow rate of regeneration water that flows through the regeneration passage 50, or whether the regeneration water flows.

The regeneration passage 50 may include a first regeneration passage 50a that is branched from the first discharge passage 30a, and a second regeneration passage 50b that is branched from the second discharge passage 30b. The regeneration passage 50 may be a passage, through which regeneration water is discharged. The first regeneration passage 50a may be connected to a first drain Da, and the second regeneration passage 50b may be connected to a second drain Db.

The regeneration valve 51 may include a first regeneration valve 51a and a second regeneration valve 51b. The regeneration valve 51 may include a first regeneration valve 51a that is disposed on the first regeneration passage 50a, and a second regeneration valve 51b that is disposed on the second regeneration passage 50b.

The regeneration sensor 52 may include a first regeneration sensor 52a and a second regeneration sensor 52b. The regeneration sensor 52 may include a first regeneration sensor 52a that is disposed on the first regeneration passage 50a, and a second regeneration sensor 52b that is disposed on the second regeneration passage 50b.

Meanwhile, the water treatment system 1 may inject a descaling material into the regeneration passage 50 to remove scale from the regeneration valve 51.

The water treatment system 1 may include a connection passage 60 and a connection valve 61. The connection passage 60 may be branched from the discharge passage 30. A point, at which the connection passage 60 is branched from the discharge passage 30, may coincide with a point, at which the regeneration passage 50 is discharged from the discharge passage 30.

The connection passage 60 may be branched from the regeneration passage 50 and may be connected to the circulation passage 40. Because the regeneration passage 50 is connected to the discharge passage 30, the connection passage 60 may connect the discharge passage 30 and the circulation passage 40 to each other.

However, the connection passage 60 is not necessarily an independent single passage, but may be a portion of the circulation passage 40, a portion of the regeneration passage 50, or a portion of the descaling part 70.

The connection passage 60 may include a first connection passage 60a that is connected to the first regeneration passage 50a, and a second connection passage 60b that is connected to the second regeneration passage 50b. The connection valve 61 may be disposed on the connection passage 60. The connection valve 61 may be disposed on the connection passage 60 to open and close the connection passage 60.

The connection valve 61 may include a first connection valve 61a that is disposed on the first connection passage 60a, and a second connection valve 61b that is disposed on the second connection passage 60b.

The water treatment system 1 may include a descaling part 70. The descaling part 70 may be connected to the connection passage 60 and may be configured to provide a descaling material for removing scale into the connection passage 60. The descaling part 70 may include at least one of citric acid and an electrolytic descaling material as a descaling material.

The descaling part 70 may include a descaling passage 71, a descaling module 72, a descaling pump 73, a descaling drain passage 74, and a pressure reducing valve 75. The descaling passage 71 may be connected to the connection passage 60. The descaling module 72 may be connected to a distal end of the descaling passage 71 and may provide a descaling material into the descaling passage 71.

As an example, the descaling module 72 may be a citric acid storage tank. The citric acid storage tank may be a storage tank for storing and discharging citric acid as a descaling material.

As another example, the descaling module 72 may be a sterilized water storage tank. The sterilized water storage tank may be a storage tank for storing and discharging a residual chlorine-based solution as a sterilizing material.

As another example, the descaling module 72 may be an electrolytic sterilization generation module. The electrolytic sterilization generation module may apply electricity to water to generate an electrolytic sterilizing material as a sterilizing material and discharge it. The electrolytic sterilization generation module may include a material generation unit that is configured to generate an electrolytic sterilizing material by using electricity, an electrolytic storage tank for storing the generated electrolytic sterilizing material, and a raw water supply line for supplying raw water.

The descaling pump 73 may be disposed on the descaling passage 71 and may be configured to pump a descaling material provided by the descaling module 72 through the descaling passage 71 to the connection passage 60.

More specifically, the descaling pump 73 may pump the descaling material so that the descaling material is introduced into the filter module 10 in a reverse direction. The reverse direction may refer to a direction that is opposite to a forward direction, which is defined as a direction in which soft water is discharged from the filter module 10.

For example, the descaling material pumped into the connection passage 60 may be introduced into the filter module 10 via the above-described regeneration passage 50 and a drain passage. Such an introduction may be an introduction in a reverse direction with respect to the filter module 10.

When the descaling material is injected into the filter module 10 in the reverse direction, a scale removal effect of the filter module 10 may be enhanced compared to a case, in which the descaling material is injected only in the forward direction.

The descaling drain passage 74 may be branched from the descaling passage 71 and may be connected to the third drain Dc. A pressure reducing valve 75 may be disposed on the descaling drain passage 74. The pressure reducing valve 75 may reduce a pressure of the descaling material or the like that flows through the descaling drain passage 74.

The water treatment system 1 may include a fitting point 80. The fitting point 80 may connect the circulation passage 40, the connection passage 60, and the descaling part 70. Through the fitting point 80, the circulation passage 40, the descaling part 70, and the regeneration passage 50 connected to the connection passage 60 may be connected to each other.

The fitting point 80, unlike the illustration of the drawings, may be a module that connects the circulation passage 40, the descaling part 70, and the regeneration passage 50 connected to the connection passage 60.

In the water treatment system 1, the descaling part 70, the circulation passage 40, and the regeneration passage 50 may be connected to each other through the fitting point 80. Accordingly, compared to a water treatment system, in which the descaling part, the circulation passage, and the regeneration passage are not connected to each other, the water treatment system 1 may provide an improved scale removal effect.

The water treatment system 1 may include a bypass passage 90, a bypass valve 91, and a bypass sensor. The bypass passage 90 may be a passage for supplying raw water to a user when soft water that has passed through the filter module 10 cannot be supplied to the demand destination H.

The bypass passage 90 may be branched from the supply passage 20 at a point that is upstream of the filter module 10 with respect to a flow direction of raw water, and may bypass the filter module 10 to be connected to the discharge passage 30.

The bypass passage 90 may connect one point of the supply passage 20, which is located on an upstream side of the supply valve 21 with respect to a flow direction of raw water, and one point of the discharge passage 30, which is located on a downstream side of the discharge valve 31 with respect to a flow direction of raw water or soft water.

In other words, the supply valve 21 may be located on a downstream side of a point, at which the bypass passage 90 is branched from the supply passage 20, with respect to a flow direction of raw water. In addition, the discharge valve 31 may be located on an upstream side of a point, at which the bypass passage 90 is connected to the discharge passage 30, with respect to a flow direction of soft water.

Accordingly, when the supply valve 21 and the discharge valve 31 are closed so that water cannot flow through the filter module 10, raw water may be guided to the demand destination H through the bypass passage 90.

The bypass passage 90 may be connected to the third discharge passage 30c, and may be connected to the discharge passage 30 at a point that is upstream of the discharge flow rate sensor 32 or the anti-freezing valve 33 with respect to a flow direction of raw water or soft water.

In other words, the discharge flow rate sensor 32 may be located on a downstream side of a point, at which the bypass passage 90 is connected to the discharge passage 30, with respect to a flow direction of soft water or raw water. Accordingly, the discharge flow rate sensor 32 may sense a flow rate of soft water discharged from the first discharge passage 30a or the second discharge passage 30b, or a flow rate of raw water discharged through the bypass passage 90.

A bypass valve 91 for opening and closing the bypass passage 90 may be disposed on the bypass passage 90. Because there is no need for water to flow through the bypass passage 90 in a situation in which soft water may be supplied to the demand destination H, the bypass valve 91 may be closed.

However, in a situation in which soft water cannot be supplied to the demand destination H during a descaling process of the filter module 10, it may be necessary to supply raw water through the bypass passage 90. In this case, the bypass valve 91 may be opened.

A bypass sensor that is configured to sense flow of raw water through the bypass passage 90 may be disposed on the bypass passage 90. The bypass sensor may be provided as a separate component from the bypass valve 91 to sense a flow rate of raw water that flows through the bypass passage 90, but may be a component included in the bypass valve 91.

The water treatment system 1 may include a controller. The controller may include a processor 100 and a memory. The processor 100 may include a microprocessor, such as a field programmable gate array (FPGA), an application specific integrated circuit (ASIC), a central processing unit (CPU), and the like.

The memory may store control instructions that are bases in generating instructions for determining whether the passages of valves are opened or closed and whether pumps are operated, in the processor. The memory may be a data store such as a hard disk drive (HDD), a solid state drive (SSD), a volatile medium, a nonvolatile medium, and the like.

The processor 100 may be electrically connected to the supply valve 21, the filter module 10, the discharge valve 31, the discharge flow rate sensor 32, the anti-freezing valve 33, the drain valve 36, the constant flow rate valve 37, the circulation pump 41, the circulation valve 42, the regeneration valve 51, the regeneration sensor 52, the connection valve 61, the descaling part 70, the bypass valve 91, and the bypass sensor.

Meanwhile, when the use of the water treatment system 1 is interrupted and then resumed, ionic material desorbed from the filter module 10 may flow to the demand destination H.

To prevent this, when the use of the water treatment system 1 is interrupted and then resumed, raw water may be supplied to the demand destination H through the bypass passage 90 while the filter module 10 is operated in the regeneration mode.

In this case, as the filter module 10 is operated in the regeneration mode, regeneration water may be discharged through the regeneration passage 50. The water treatment system 1 according to an embodiment of the present disclosure is a system that improves a recovery rate by reducing an amount of regeneration water that is discarded as the filter module 10 is driven in the regeneration mode. The recovery rate may refer to a ratio of the volume of soft water to a sum of the volumes of soft water and regeneration water in the water treatment system 1.

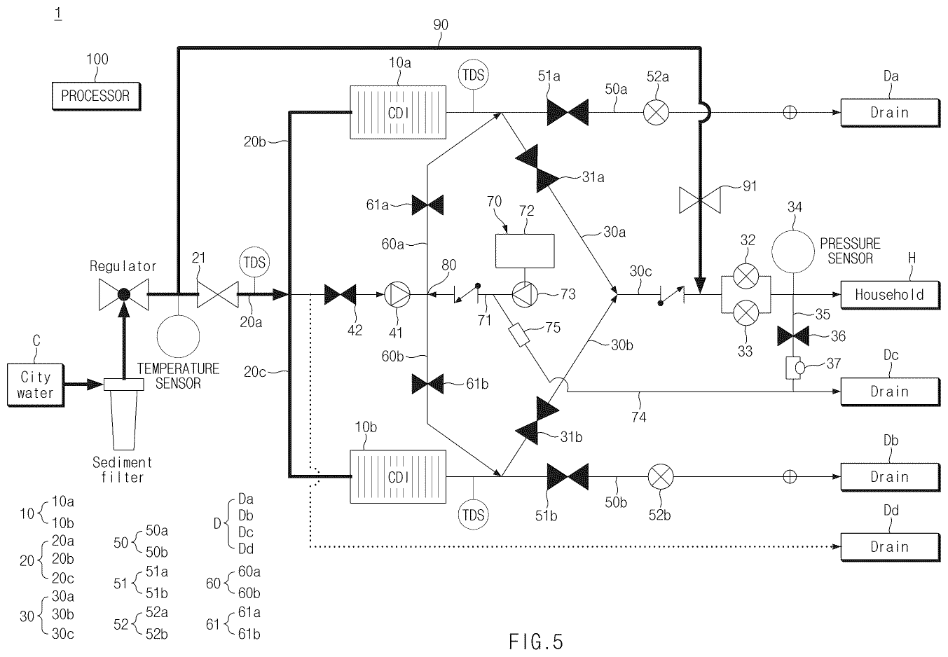

Hereinafter, with reference to FIGS. 5 to 10, a control of a water treatment system 1 according to an embodiment of the present disclosure will be described in detail.

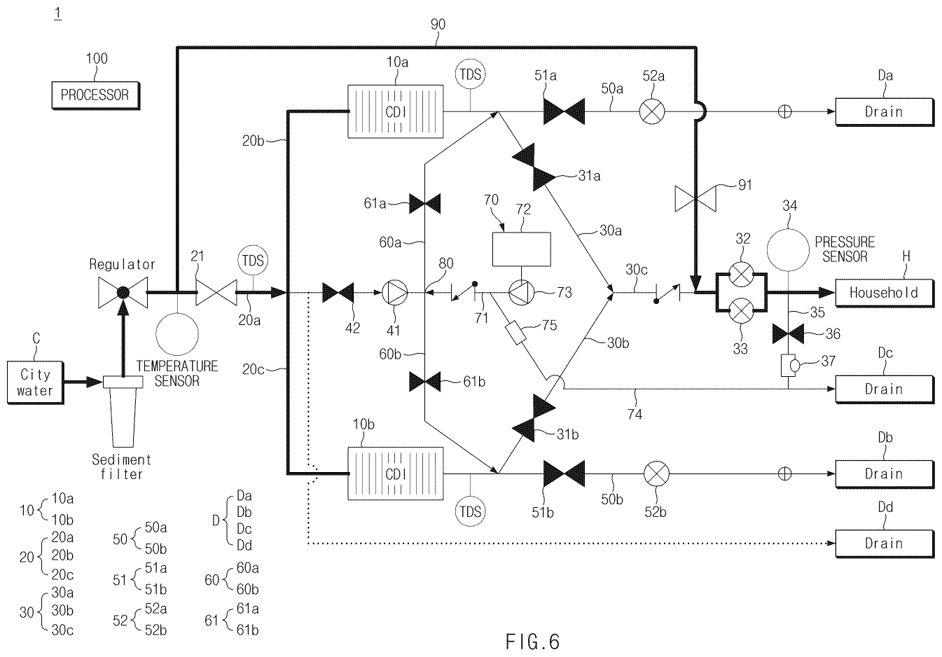

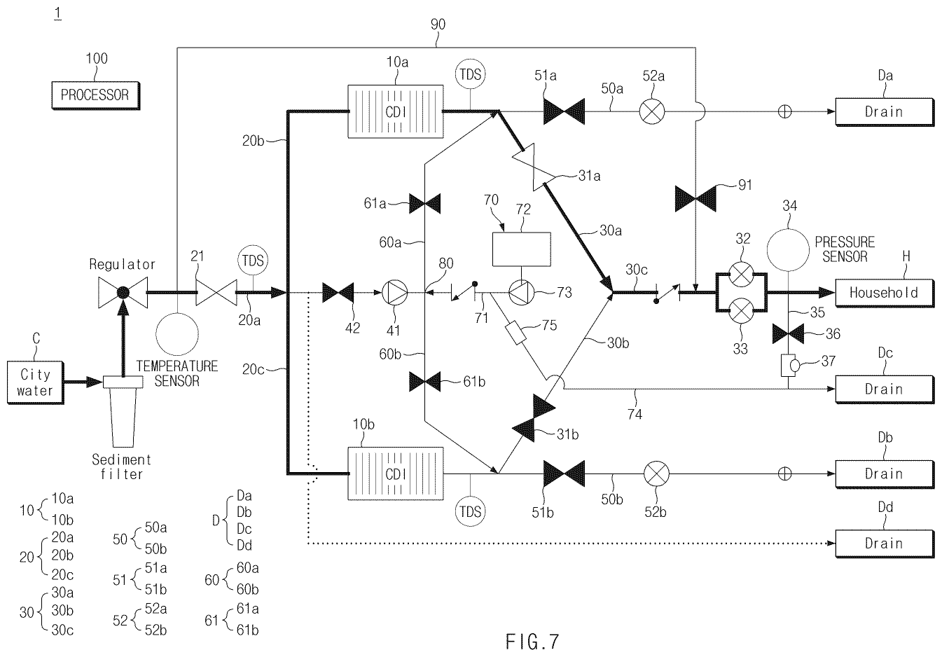

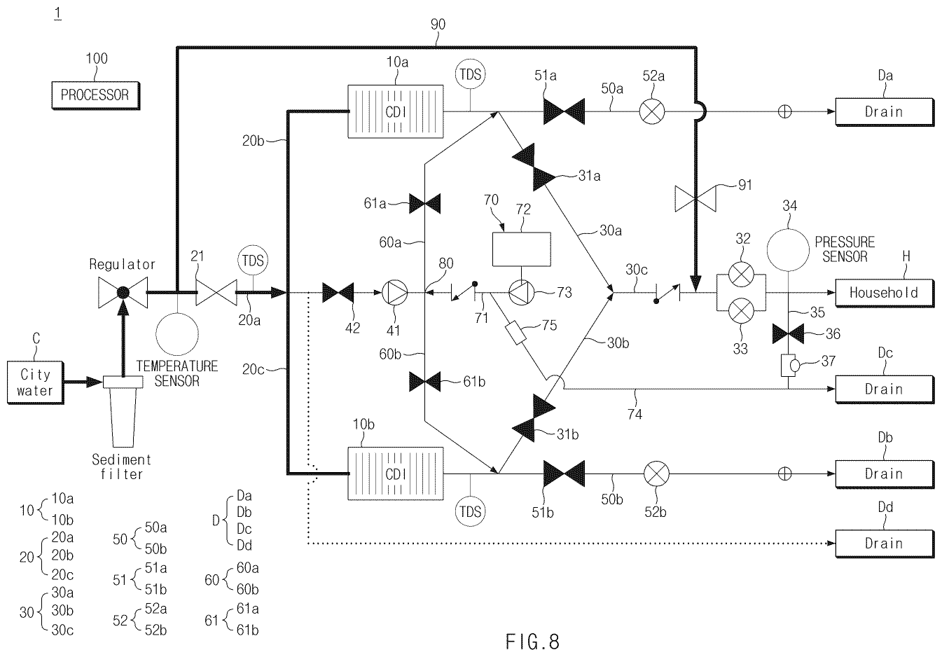

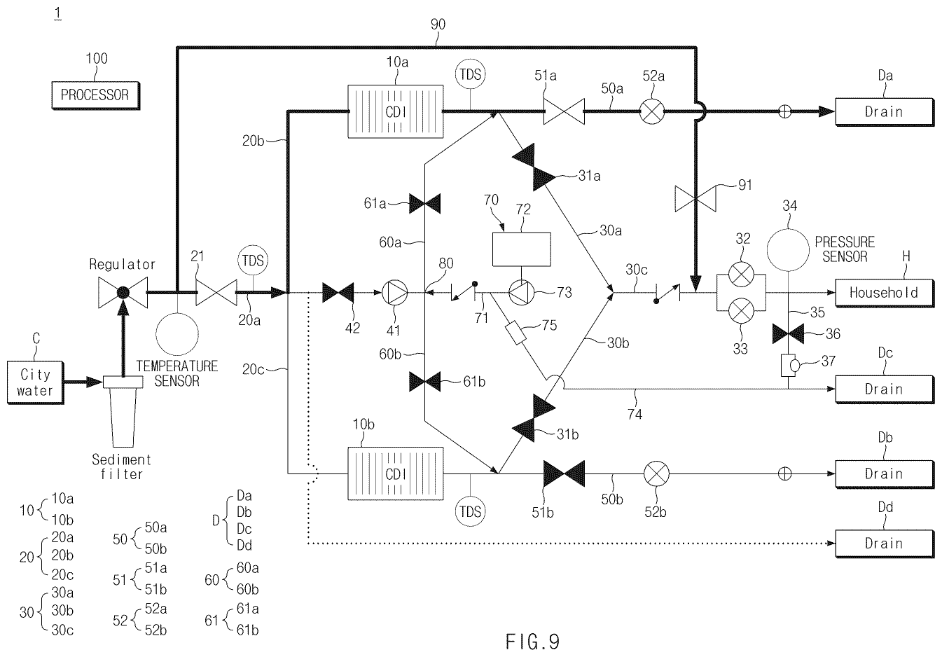

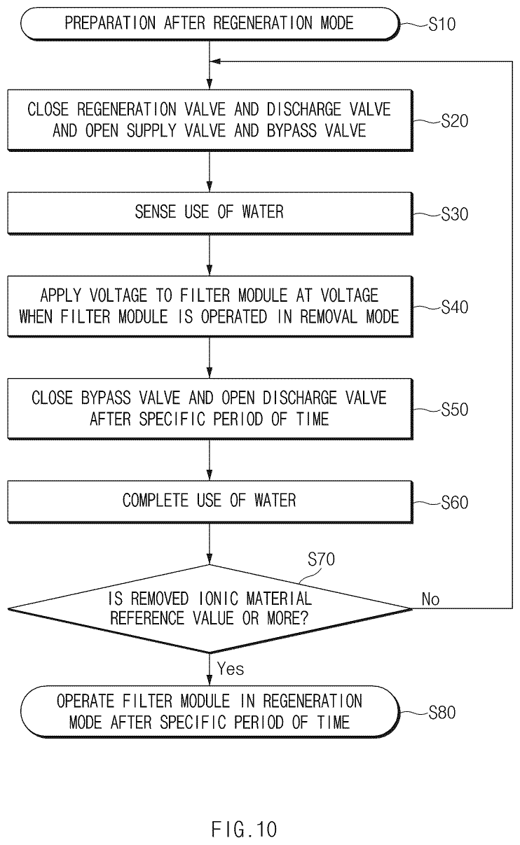

FIGS. 5 and 6 are schematic views of a water treatment system, in which raw water is delivered to a demand destination through a bypass passage, according to an embodiment of the present disclosure. FIG. 7 is a schematic view of a water treatment system, in which a filter module is operated in a removal mode to deliver soft water to a demand destination, according to an embodiment of the present disclosure. FIG. 8 is a schematic view of a water treatment system, which is interrupted, according to an embodiment of the present disclosure. FIG. 9 is a schematic view of a water treatment system when a filter module is operated in a regeneration mode according to an embodiment of the present disclosure. FIG. 10 is a flowchart illustrating a method for controlling a water treatment system, according to an embodiment of the present disclosure.

With reference to FIGS. 5 and 10, when use of the water treatment system 1 is interrupted, the filter module 10 may be provided in a preparation state after being driven in the regeneration mode (S10).

Thereafter, when the water treatment system 1 is reused, as illustrated in FIG. 5, raw water may be supplied through the bypass passage 90 without passing through the filter module 10. In this case, the regeneration valve 51 and the discharge valve 31 may be closed, and the supply valve 21 and the bypass valve 91 may be opened (S20).

In other words, it may be prevented that regeneration water or soft water flows through the regeneration passage 50 and the discharge passage 30, and it may be allowed that raw water flows through the supply passage 20 and the bypass passage 90.

When raw water is supplied to the demand destination H through the bypass passage 90, the bypass sensor may sense that the raw water flows through the bypass passage 90 (S30).

With reference to FIGS. 6 and 10, when it is sensed by the bypass sensor that raw water flows through the bypass passage 90, the processor 100 may control a voltage to be applied to the filter module 10.

In this case, raw water may also be supplied to the filter module 10; but the discharge valve 31 may close the discharge passage 30 so that raw water or soft water discharged from the filter module 10 is prevented from flowing through the discharge passage 30.

The processor 100 may apply a voltage to the filter module 10 at a voltage level used in the removal mode in response to it being sensed by the bypass sensor that raw water flows through the bypass passage 90 (S40).

According to this principle, while raw water is supplied to the demand destination H through the bypass passage 90, a voltage used when the filter module 10 is operated in the removal mode is applied to the filter module 10, and thus, desorption of ions (ionic material) from the filter module 10 into the raw water may be prevented.

For a specific period, during which a voltage is applied to the filter module 10, the regeneration valve 51 and the discharge valve 31 may remain closed to block the regeneration passage 50 and the discharge passage 30, respectively, and the supply valve 21 and the bypass valve 91 may remain open to open the supply passage 20 and the bypass passage 90, respectively.

With reference to FIGS. 7 and 10, after a specific period of time has elapsed from a time point, at which a voltage used in the removal mode is applied to the filter module 10, the processor 100 may control the bypass valve 91 and the discharge valve 31.

More specifically, after a voltage used in the removal mode is applied to the filter module 10 for a specific period of time, the processor 100 may control the bypass valve 91 to close the bypass passage 90 (S50).

In addition, after a voltage used in the removal mode is applied to the filter module 10 for a specific period of time, the processor 100 may control the discharge valve 31 to open the discharge passage 30 (S50).

Via this process, the demand destination H is supplied with soft water, from which ionic material contained in raw water has been removed through the filter module 10. Accordingly, it becomes possible to reduce the amount of regeneration water that may be discarded as the filter module 10 is operated in the regeneration mode, without such control. That is, a recovery rate of the water treatment system 1 according to an embodiment of the present disclosure may be increased.

With reference to FIGS. 8 and 10, when use of the water treatment system 1 is completed, it may be identified that the use of water in the water treatment system 1 has been completed, by the discharge flow rate sensor 32 (S60).

Thereafter, the processor 100 may acquire information on an amount of ionic material removed by the filter module 10.

That is, the processor 100 may acquire information on an amount of ionic material removed by the filter module 10 in response to it being identified that soft water or raw water does not flow through the discharge passage 30, by the discharge flow rate sensor 32. Here, the information on the amount of ionic material removed may be used to be compared with an adsorption capacity of the filter module 10.

The processor 100 may compare the amount of the removed ionic material with a specific reference value (S70). Here, the specific reference value may be approximately 50% of an adsorption capacity that may be removed by the filter module 10, but is not limited thereto.

Furthermore, the information on the amount of the removed ionic material may be estimated by the processor 100 or may be measured by the filter module 10.

The processor 100 may be configured to apply a voltage to the filter module 10 at a voltage used when the filter module 10 is operated in the removal mode or at a voltage used when the filter module 10 is operated in the regeneration mode, based on the amount of the removed ionic material. Here, a voltage applied to the filter module 10 when the filter module 10 operates in the regeneration mode may be an opposite voltage to a voltage that is applied to the filter module 10 when it is operated in the removal mode.

When the amount of the removed ionic material is less than the reference value (No of S70), the processor 100 may determine that the ionic material contained in the raw water has been relatively insufficiently removed, and control the regeneration valve 51, the discharge valve 31, the supply valve 21, and the bypass valve 91 (S20).

More specifically, when the amount of the removed ionic material is less than the reference value, the processor 100 may control the bypass valve 91 to open the bypass passage 90 (S20). That is, the processor 100 may control the bypass valve 91 such that the bypass passage 90 is opened in response to the amount of the removed ionic material being less than the reference value. When the amount of the removed ionic material is less than the reference value, the processor 100 may control the supply valve 21 to open the supply passage 20. That is, the processor may control the supply valve 21 such that the supply passage 20 is opened in response to the amount of the removed ionic material being less than the reference value.

When the removed ionic material is less than a reference value, the processor 100 may control the discharge valve 31 to close the discharge passage 30. That is, the processor 100 may control the discharge valve 31 such that the discharge passage 30 is closed in response to the amount of the removed material being less than the reference value. Furthermore, when the removed ionic material is less than a reference value, the processor 100 may control the regeneration valve 51 to close the regeneration passage 50. That is, the processor 100 may control the regeneration valve 51 such that the regeneration passage 50 is closed in response to the amount of the removed ionic material being less than the reference value.

The processor 100 may close the discharge passage 30 and the regeneration passage 50, open the supply passage 20 and the bypass passage 90, and, when it is identified that raw water flows again through the bypass passage 90 (S30), may apply a voltage, which is used when the filter module 10 is operated in the removal mode, to the filter module 10 (S40).

Through this process, when it is determined that ionic material included in raw water is not sufficiently removed, the water treatment system 1 may open the supply passage 20 and the bypass passage 90 so that raw water is supplied to the demand destination H, while closing the discharge passage 30 to prevent the ionic material from being supplied to the demand destination H, and closing the regeneration passage 50 to prevent regeneration water from being discharged through the regeneration passage 50.

Meanwhile, referring to FIGS. 9 and 10, when the amount of removed ionic material a reference value or more (Yes of S70), the processor 100 may control the filter module 10 to be operated in a regeneration mode after a specific period of time (S80). That is, the processor 100 may control the filter module 10 such that the filter module 10 is operated in the regeneration mode after the specific period of time in response to the amount of the removed ionic material being the reference value or more.

That is, when the amount of removed ionic material a reference value or more, the processor 100 may apply a voltage, which is opposite to the voltage applied in the removal mode, to the filter module 10, or may not apply a voltage to the filter module 10, so that the filter module 10 is operated in the regeneration mode after a specific period of time.

Accordingly, the filter module 10 may be operated in the regeneration mode, such that the ionic material adsorbed in the filter module 10 is contained in raw water and discharged as regeneration water through the regeneration passage 50 to the first and second drains Da and Db.

According to an embodiment of the present disclosure, when the water treatment system is resumed after being interrupted, an amount of regeneration water that would otherwise be wasted may be reduced, so that a recovery rate may be improved.

The above description is merely an example of the technical idea of the present disclosure, and various modifications and variations may be made by one skilled in the art without departing from the essential characteristic of the present disclosure. Accordingly, embodiments of the present disclosure are intended not to limit but to explain the technical idea of the present disclosure, and the scope and spirit of the present disclosure is not limited by the above embodiments. The scope of protection of the present disclosure should be construed by the attached claims, and all equivalents thereof should be construed as being included within the scope of the present disclosure.

What is claimed is:

1. A water treatment system comprising:
a filter module configured to be operated in a removal mode, in which a voltage is applied to remove at least a portion of ionic material included in raw water based on an electrical force and discharge soft water, and in a regeneration mode for regenerating an electrode;
a supply passage configured to supply the raw water to the filter module;
a discharge passage configured to guide the soft water discharged from the filter module to a demand destination;
a bypass passage branched from the supply passage at a point on an upstream side of the filter module with respect to a flow direction of the raw water, and connected to the discharge passage while bypassing the filter module;
a bypass sensor disposed on the bypass passage, and configured to sense flow of the raw water through the bypass passage; and
a processor electrically connected to the filter module and the bypass sensor,
wherein the processor is configured to:
apply a voltage to the filter module at a voltage level used in the removal mode, in response to the flow of the raw water through the bypass passage being sensed by the bypass sensor.

2. The water treatment system of claim 1, further comprising:
a bypass valve disposed on the bypass passage, configured to open and close the bypass passage, and electrically connected to the processor,
wherein the processor is configured to:
control the bypass valve such that the bypass passage is closed after the voltage at the level used in the removal mode is applied to the filter module for a specific period of time.

3. The water treatment system of claim 2, further comprising:
a discharge valve disposed on the discharge passage, configured to open and close the discharge passage, and electrically connected to the processor,
wherein the processor is configured to:
control the discharge valve such that the discharge passage is opened after the voltage at the level used in the removal mode is applied to the filter module for the specific period of time.

4. The water treatment system of claim 3, wherein the discharge valve is located on an upstream side of a point, at which the bypass passage is connected to the discharge passage, with respect to a flow direction of the soft water.

5. The water treatment system of claim 3, further comprising:
a discharge flow rate sensor provided on the discharge passage, configured to measure a flow rate of the soft water or the raw water flowing through the discharge passage, and electrically connected to the processor,
wherein the processor is configured to:
acquire information on an amount of the ionic material removed by the filter module in response to the discharge flow rate sensor sensing that the soft water or the raw water does not flow through the discharge passage.

6. The water treatment system of claim 5, wherein the processor is configured to:
apply a voltage to the filter module at the voltage when the filter module is operated in the removal mode or an opposite voltage to the voltage, based on the amount of the removed ionic material.

7. The water treatment system of claim 5, wherein the processor is configured to:
control the filter module such that the filter module is operated in the regeneration mode after a specific period of time in response to the amount of the removed ionic material being a reference value or more.

8. The water treatment system of claim 5, wherein the processor is configured to:
control the bypass valve such that the bypass passage is opened in response to the amount of the removed ionic material being less than a reference value.

9. The water treatment system of claim 5, further comprising:
a discharge valve disposed on the discharge passage, configured to open and close the discharge passage, and electrically connected to the processor,
wherein the processor is configured to:
control the discharge valve such that the discharge passage is closed in response to the amount of the removed material being less than a reference value.

10. The water treatment system of claim 5, further comprising:
a regeneration passage branched from the discharge passage; and
a regeneration valve disposed on the regeneration passage, configured to open and close the regeneration passage, and electrically connected to the processor,
wherein the processor is configured to:
control the regeneration valve such that the regeneration passage is closed in response to the amount of the removed ionic material being less than a reference value.

11. The water treatment system of claim 5, further comprising:
a supply valve located on a downstream side of a point, at which the bypass passage is branched from the supply passage, with respect to a flow direction of the raw water, configured to open and close the supply passage, and electrically connected to the processor,
wherein the processor is configured to:
control the supply valve such that the supply passage is opened in response to the amount of the removed ionic material being less than a reference value.

12. The water treatment system of claim 5, wherein information on the amount of the removed ionic material is estimated by the processor or measured by the filter module.

13. The water treatment system of claim 7, wherein the reference value is formed as 50% of an adsorption capacity of the filter module.

14. The water treatment system of claim 5, wherein the discharge flow rate sensor is located on a downstream side of a point at which the bypass passage is connected to the discharge passage, with respect to a flow direction of the soft water or the raw water.
